(19) United States
(12) Patent Application Publication
(10) Pub. No.: US 2008/0074546 A1
(43) Pub. Date: Mar. 27, 2008

(54) WARNING SIGNAL INTERRUPT DEVICE

(76) Inventor: Abdulmohsen A. Momen, Kuwait (KW)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/533,973

(22) Filed: Sep. 21, 2006

(51) Int. Cl. H04N 7/00; H04N 5/44

(52) U.S. Cl. 348/553; 348/552

(57) ABSTRACT

A warning and signal interrupt device for preventing a child from sitting to close to a TV includes a pressure mat for defining an area and sending a signal when an individual is within that area. The device also includes a timer for timing a period when the individual remains in the area. When the timer exceeds a first pre-selected increment of time, the device sounds an alarm which continues until the individual vacates the area. Then when the period of time exceeds a second pre-selected time interval, the device turns off the picture and mutes the TV sound. The device also restarts the TV when the individual moves outside of the area. A method for automatically training a child to sit at a proper distance from a TV screen is also disclosed.

### FIELD OF THE INVENTION

This invention relates to a warning and signal interrupt device and more particularly to a device for preventing one or more individuals from occupying a space in front of and in relatively close proximity to a television screen. The invention also relates to a method for training children to maintain a safe distance from a television screen during viewing.

### BACKGROUND FOR THE INVENTION

Devices to determine whether or not a television is viewer positioned within a predetermined potentially harmful distance in front of a television set are known. For example, a U.S. Pat. No. 4,843,464 of Choi discloses a Device for Automatic Sensing of Televiewing Distance. As disclosed, the device uses the elapsed time difference between an ultrasonic pulse generated and emitted from a transmitter located on the television set and which is then reflected from a televiewer located in front of the television set. The reflected pulse is then received by an ultrasonic wave receiver also located on the television set. In the event that the televiewer stands within the predetermined distance for a time longer than is required, for example, to make a manual adjustment to the television set, a signal is generated which deactivates the video portion of the television set until such time that the televiewer moves to a safe distance away from the set beyond the predetermined harmful distance at which time the video portion is again reactivated.

A more recent U.S. Pat. No. 5,408,276 of Morales, discloses a Safe Viewing Distance For A Television By Means Of An Antenna Interrupt Device. The Morales signal interrupt device is connected externally to an electronic device such as a television set to sense when a person is within a predetermined minimum distance from the surface of the television set. The device is connected to the TV with the wire or cable providing incoming television (TV) signals to the television set and a normally closed switch which is effectively opened when a person is sensed within the predetermined minimum distance, consequently interrupting the signals to the television.

A further approach for controlling the operation of a television set is disclosed in a U.S. Pat. No. 6,259,486 of Mahvi. The Mahvi patent discloses a viewer's presence sensor unit for controlling operation of a television set. The sensor unit first includes a detector for sensing the presence of a living being near the television set and a timer for measuring the amount of time of non-presence of a living being. Second, the sensor unit incorporates a power interruption switch activated by the detector for terminating power to the TV set upon reaching a measurement of a term of time of non-presence of a living being. Detectors can be chosen from motion sensors and heat sensors and preferably have utility up to a reasonable viewing distance from the television set. In this manner, TV sets not in use are automatically turned off to conserve resources otherwise expended as a result of non-viewed operated sets.

Notwithstanding the above, it is presently believed that there is a need and a potential market for an improved warning and signal interrupt device in accordance with the present invention. There should be a market for such devices because they define an area which may subject a viewer to the harmful effects of ultraviolet rays produced from the picture of a television.

Further, the devices in accordance with the present invention are particularly applicable to prevent children from creeping back in front of the screen when their parents are less attentive and provides reinforcement for training the children to view television from a safe distance. Such devices provide a warning to alert a viewer or parent that they or their children are too close to the set and if they persist interrupts the picture and/or sound.

The devices in accordance with the present invention are relatively inexpensive, easy to install and/or remove and require little or no maintenance. Such devices are also hidden from view and thus do not detract from the surrounding decor.

### BRIEF SUMMARY OF THE INVENTION

In essence, the present invention contemplates a warning and signal interrupt device for preventing one or more individuals from occupying a space in front of and in close proximity to a television screen. The device includes means such as a pressure mat for outlining a defined area in front of and in close proximity to a television screen. For example, the mat may be of generally rectangular shape and of sufficient size to cover an area in front of the TV which may be harmful to a viewer. The mat also acts as a pressure switch for indicating the presence of one or more individuals within the defined area. Timing means such as a timer are provided for measuring the duration that one or more individuals remain in the defined area. The device also includes audio means such as a buzzer for sounding a warning when one or more individuals remain in the defined area for a first pre-selected period of time, as for example, about 15 seconds. The buzzer continues to sound as long as an individual is on the mat i.e. within the defined area. Means for interrupting a television signal is also provided if an individual remains on the mat for a second pre-selected period of time. For example, if one or more individuals remain in the defined area for a period of about 30 seconds the video is turned off and/or the sound muted. In this way, children can be trained to remain at a safe distance from the screen. The device also includes circuit means for resetting the timer, and restoring the sound and picture when the defined area has been vacated.

The invention will now be described in connection with the accompanying drawings wherein like numbers have been used to identify like parts.

### DESCRIPTION OF THE DRAWINGS

FIG. 1 is a perspective view illustrating a television set equipped with a warning and signal interrupt device in accordance with the invention and wherein a child is sitting in an area that activates the device;

FIG. 2 is a perspective view illustrating a television set equipped with a warning and signal interrupt device in accordance with the invention and wherein a child is sitting outside of the area for deactivating the television;

FIG. 3 is a circuit diagram of a circuit for use in the present invention;

FIG. 4 is a top or plane view of a circuit board, battery, plug and TV connector for use in the present invention;

FIG. 5 illustrates a typical connection between a TV set and a VCR and/or DVD player; and

FIG. 6 illustrates a connection between a TV set and a VCR and/or DVD player with a warning signal interrupt device in accordance with the present invention.

### DESCRIPTION OF THE PREFERRED EMBODIMENTS OF THE INVENTION

The primary purpose of the present invention is to keep children from sitting to close to a TV screen and to train the children to sit at a proper distance from the screen.

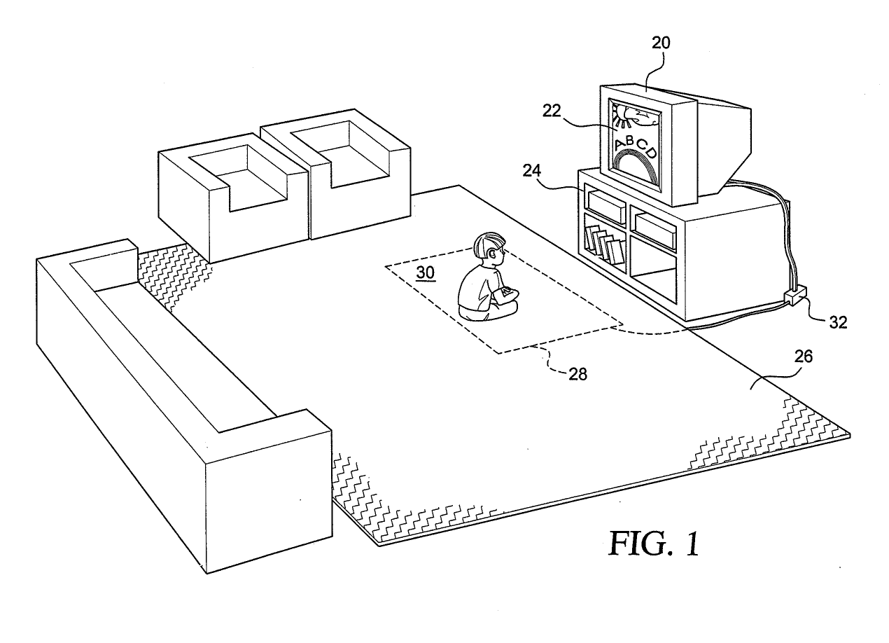

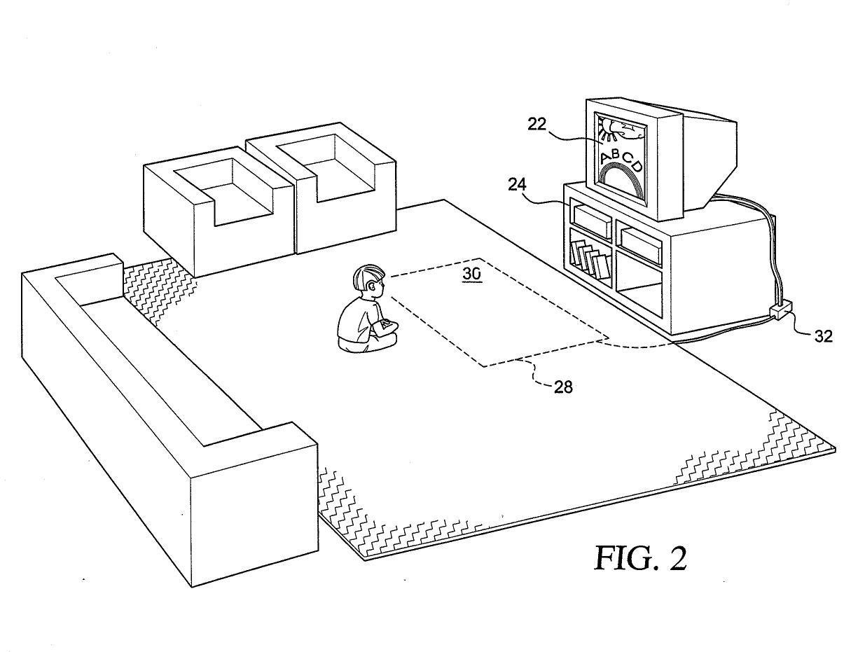

As illustrated in FIG. 1 a television set 20 with a screen 22 is positioned on a stand 24 in front of a carpet 26. A pressure mat 28 is positioned in front of the screen 22 and under the carpet 26 and outlines a defined area 30 that is too close to the screen for safe viewing. For example, FIG. 1 shows a child sitting in front of the screen 22 within the defined area 30. As illustrated the television set is equipped with a warning and signal interrupt device 32 shown schematically which triggers an audio alert or warning when a first pre-selected period of time as for example 15 seconds has passed. The alarm may be equipped to increase intensity as the time passes until a second pre-selected time has been reached. When the second pre-selected time has been reached the video and/or audio signal is turned off so that there is a neutral screen and muted sound.

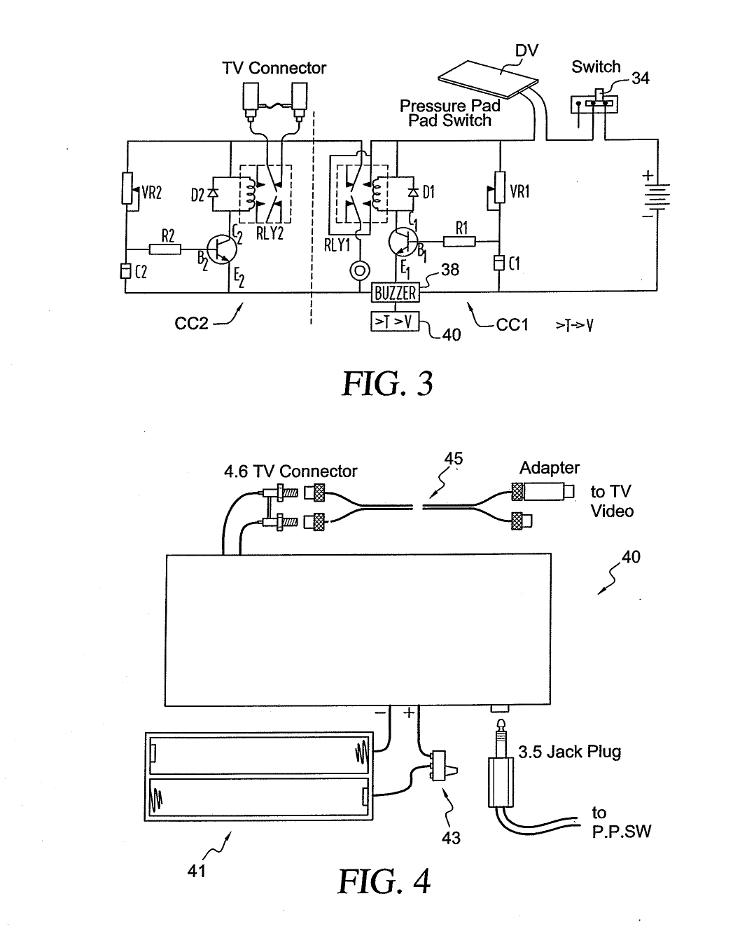

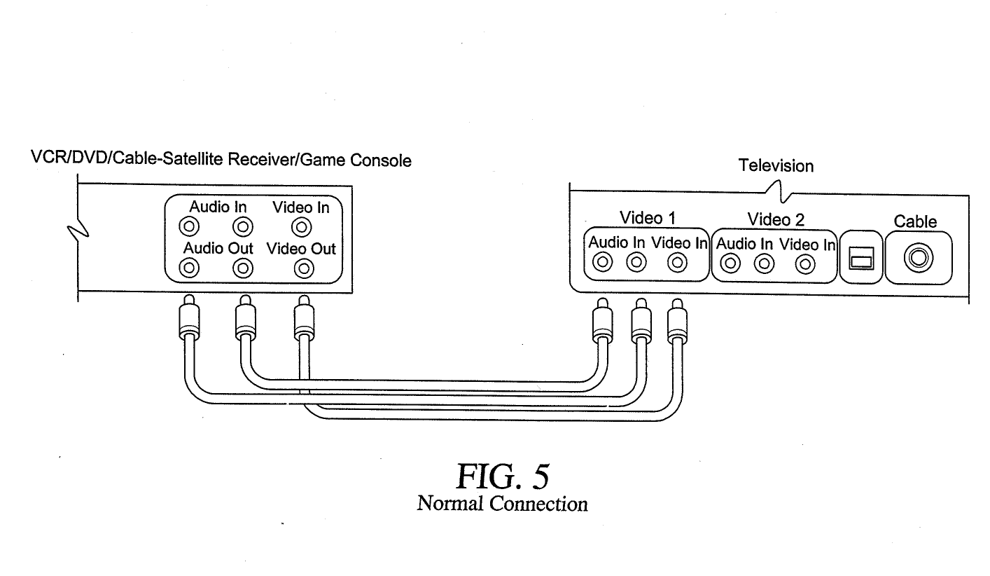

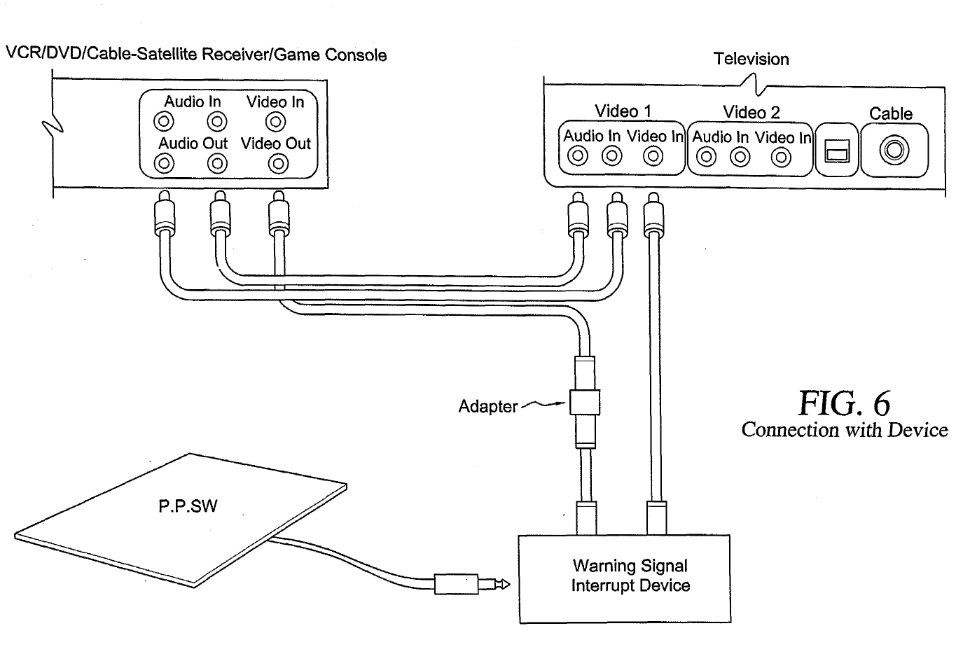

An electrical circuit for operating the device in accordance with a preferred embodiment of the invention is illustrated in FIG. 3. As shown, the pressure pad or mat 30 is connected to a source of power such as a battery 32 through a master switch 34. The master switch is used to turn off the device if there is a need to adjust the set or to remain in the area for an extended period of time.

When a child or other individual steps on or sits on the mat 30, electrical energy is supplied to a versa VR1, the output of which charges a capacitor C1 in a previously selected period of time as for example 15 seconds. Then when the capacitor C1 reaches its set value, the contact B1 of a first transistor TR1 connects the terminals e₁ and c₁ which are then connected to a first relay RLY1. This causes a buzzer 38 to emit an audio sound. It is also contemplated that a conventional circuit 40 may be added to increase the loudness of the audio sound as the period of time that the child remains on the mat is extended.

The relay RLY1 which includes a coil and a diode D1 also connects the power to a second portion of the circuit. The second portion of the circuit like the first portion includes a varistor VR2 the output of which charges a capacitor C2 in a second previously selected period of time as for example 30 seconds. Then when the capacitor reaches its set value the contact b₂ of a second transistor TR2 connects the terminals e₂ and c₂ which are then connected to a second relay RLY2. This feeds a video signal through a TV connector to turn off the TV set 20 (not shown in FIG. 3).

FIG. 4 shows a circuit board 40, battery 42 and TV connectors 44 as incorporated in a device in accordance with the present invention. As shown, a battery pack 41 includes four double A batteries and provides a 6 volt output through a switch 43. The output of a second portion of the circuit described in connection with FIG. 3 is connected to a TV set by means of a pair of cables 45 in a conventional manner. The pressure pad 28 (not shown in FIG. 4) is connected by means of a conventional jack plug 46 to the circuit board 40.

When the area defined by the pressure pad is vacated the first and/or second relay RLY1 and RLY2 disconnect the buzzer and restore power to the TV set in a conventional manner.

The present invention also contemplates a method for automatically training a child to sit at a proper distance from a TV screen and to overcome a child's tendency to crawl forward and closer to the screen when adult supervision is absent.

The method for automatically training children to view television programs from a proper distance comprises the following steps. An area in front of and in close proximity to a television screen wherein a viewer maybe exposed to harmful radiation is defined by a pressure mat or the like which is preferably disposed below the carpet. The pressure mat includes a switch to produce a signal when a child is present in the defined area. Then when a child is within the defined area that is on the pressure mat for duration of time as for example 15 seconds a buzzer is sounded. In one embodiment of the invention, this buzzer increases in loudness as the time of occupancy continues. In addition, to sounding an audio warning, when a child remains in the defined area for a second period of time the TV signal is interrupted or the TV merely turned off. When the child leaves the area the TV picture is restored.

While the invention has been described in connection with its preferred embodiments it should be recognized that changes and modifications may be made therein without departing from the scope of the appended claims.

What is claimed is:

1. A warning and signal interrupt device for preventing one or more individuals from occupying a space in front of and in close proximity to a television screen, said device comprising:
means defining a defined area in front of and in close proximity to a television screen;
means including a pressure switch for determining when one or more individuals are within the defined area;
timing means for timing the duration that one or more individuals are within the defined area;
means for sounding a warning when one or more individuals have been within the defined area for a first pre-selected period of time;
means for interrupting a television signal when one or more individuals have been within the defined area for a second pre-selected period of time; and
means for resetting the timing means when all individuals within the defined area have vacated the area.

2. A warning and signal interrupt device according to claim 1 in which said means for defining a defined area is a pressure mat.

3. A warning and signal interrupt device according to claim 2 in which said first pre-selected time is about 15 seconds.

4. A warning and signal interrupt device according to claim 3 in which said second pre-selected time is about 30 seconds.

5. A warning and signal interrupt device according to claim 2 in which said timing means is variable for selecting first and second time period.

6. A warning and signal interrupt device according to claim 5 which includes an electrical circuit, said circuit comprising a veristar and capacitor for providing a first selected time interval, a buzzer, a first relay and a first transistor for actuating said relay after a first selected period of time has passed to thereby cause said buzzer to emit a sound.

7. A warning and signal interrupt device according to claim 6 in which said electrical circuit includes a second veristar and a second capacitor for providing a second pre-selected period of time, a switch, a second relay and a second transistor for actuating said second relay after said second pre-selected period of time has passed to thereby turn off the TV.

8. A warning and signal interrupt device according to claim 7 which includes a master switch for turning off the device and in which each of said relays includes a diode.

9. A method for training children to view television programs from a proper distance comprising the steps of:
defining an area in front of and in close proximity to a television screen wherein a viewer may be exposed to harmful radiation;
providing a pressure mat including a switch to produce a signal when a child is present in the defined area;
measuring the duration of time that the child is within the defined area;
sounding an audio warning when a child remains in the defined area beyond a first pre-selected time;
interrupting the TV signal when a child remains in the defined area beyond a second pre-selected time; and
restoring the TV picture and silencing the audio alarm when the child moves outside of the defined area.

10. A warning and signal interrupt device according to claim 10 which includes the further step of increasing the volume of the audio warning as the time exceeds the first pre-selected time.
